(19) United States
(12) Patent Application Publication
(10) Pub. No.: US 2016/0117196 A1
(43) Pub. Date: Apr. 28, 2016

(54) LOG ANALYSIS

(71) Applicant: HEWLETT-PACKARD DEVELOPMENT COMPANY, L.P., Houston, TX (US)

(72) Inventors: Vanish Talwar, Palo Alto, CA (US); Indrajit Roy, Palo Alto, CA (US); Kevin T. Lim, Palo Alto, CA (US); Jichuan Chang, Palo Alto, CA (US); Parthasarathy Ranganathan, Palo Alto, CA (US)

(21) Appl. No.: 14/898,518

(22) PCT Filed: Jul. 31, 2013
(86) PCT No.: PCT/US2013/053060

§ 371 Date: Dec. 15, 2015

(51) Int. Cl. G06F 9/50; H04L 29/08

(52) U.S. Cl. CPC G06F 9/5016; H04L 67/1097

(57) ABSTRACT

Log analysis can include transferring compiled log analysis code, executing log analysis code, and performing a log analysis on the executed log analysis code.

### BACKGROUND

Data can be collected, or “logged”, and logged data and messages (also known as logs) can be emitted by network devices, operating systems, and applications, among others. Logs may be collected and analyzed.

Log analysis can be utilized to make sense of computer-generated records (e.g., log records). Log analysis is applicable in a variety of scenarios including, for example, security analysis, information technology (IT) performance management, web analytics, clickstream analysis, debugging, troubleshooting, and network management, among others.

### BRIEF DESCRIPTION OF THE DRAWINGS

FIG. 1 illustrates an example log analysis architecture according to the present disclosure.

FIGS. 2A-2B illustrate examples of systems for log analysis according to the present disclosure.

FIGS. 3A-3B illustrate flow charts of examples of methods for log analysis according to the present disclosure.

### DETAILED DESCRIPTION

The volume, velocity, and variety of log data and log analysis code is growing and may create challenges for effective log analysis in real-time and for quality insights. Prior approaches to log analysis include executing log analysis code on dedicated servers. These servers are different from the servers generating the logs, and log data is streamed or loaded in batches over the network. This incurs increased latency access to log data and also incurs costs of additional dedicated servers for log analysis. Other approaches have used management processors on the servers generating the log data to do log analysis. However these prior management processors have been limited in scope and do not have direct access to memory or storage resulting in higher latency access to log data at lower overall bandwidth.

Some log analysis code can run locally on a machine that generates the logs, (e.g., the code is run on a host central processing unit (CPU)) but this can interfere with other applications running on the host and can impact performance for log analysis code and other applications.

In contrast, log analysis in accordance with the present disclosure leverages active devices which have passive storage elements (e.g., active memory and/or storage) to improve performance of log analytics. For example, log analysis can be executed on an active device architecture, where active devices can provide computation close to storage and/or memory, providing opportunities for improved performance due to increased data bandwidth and decreased latency.

Log analysis in accordance with the present disclosure can support real-time and online log analysis, and can reduce time to insight when problems occur (e.g., when log analysis involves finding problems). Log analysis in accordance with the present disclosure can offload log analysis from a host system, reducing interference. Additionally or alternatively, log analysis in accordance with the present disclosure can reduce energy costs, simplify host processor designs, and reduce data movement of log data within a local machine and across networks.

An active device can include an active element (e.g., at least one active element) co-located with a passive storage element (e.g., a set of passive storage elements). An example of an active element can include a processing element, such as, for example, a general purpose CPU or specialized accelerator (e.g., graphics processing units (GPUs)) and/or a programmable logic device such as a field-programmable gate array (FPGA) co-located with a local memory.

A passive storage element can include a hard drive, solid-state drive (SSD) dynamic random-access memory (DRAM), and/or flash memory, among others. A passive storage element can also include future non-volatile memory, such as a Memristor, phase-change random-access memory (PCRAM), and/or spin-transfer torque random-access memory (STT-RAM), among others.

A log can include, for example, a security log, a security event, an operating system performance monitoring log, a hardware monitoring log, an application log, a business process log, and an event trigger, among others. Log analysis can include, for instance, log filtering, log cleaning, arranging logs in a particular schemes, log parsing, searching logs (e.g., string searches, expression searches, keyword searches, structured query language (SQL) queries, etc.), time-series analysis, statistical functions (e.g., sums, averages, probabilities), anomaly detection, pattern detection, machine learning applications and models (e.g., algorithms), security patterns (e.g., login and/or access patterns), physical infrastructure analysis, hardware management, and functionality monitoring, among others.

In the following detailed description of the present disclosure, reference is made to the accompanying figures that form a part hereof, and in which is shown by way of illustration how examples of the disclosure may be practiced. The figures herein follow a numbering convention in which the first digit or digits correspond to the drawing figure number and the remaining digits identify an element or component in the drawing. The proportion and the relative scale of the elements provided in the figures are intended to illustrate the examples of the present disclosure, and should not be taken in a limiting sense. As used herein, “a number of” an element and/or feature can refer to one or more of such elements and/or features.

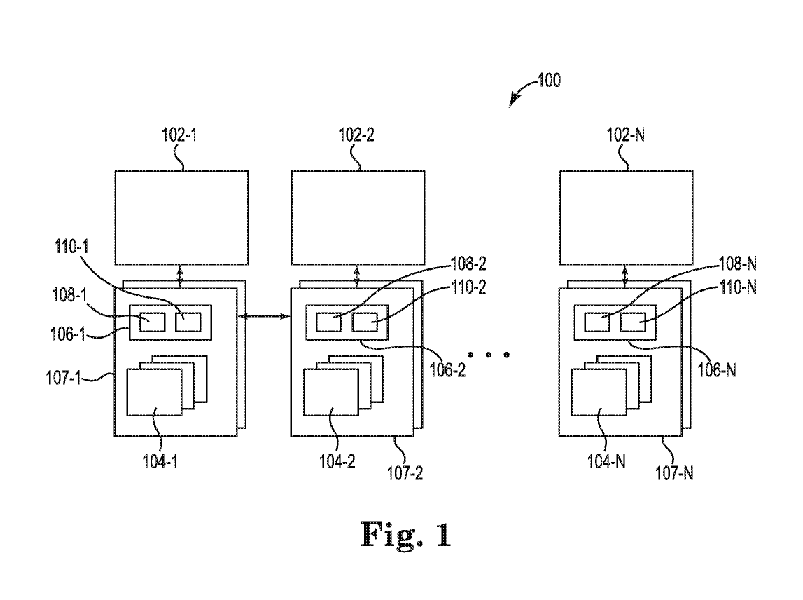

FIG. 1 illustrates an example log analysis architecture 100 according to the present disclosure. Architecture 100 can include a host processing resource (e.g., host CPU) 102-1, 102-2, . . . , 102-N that may be communicatively coupled to an active device 107-1, . . . , 107-N. Active device 107-1, . . . , 107-N can include an active element 106-1, 106-2, . . . , 106-N and a passive storage element 104-1, 104-2, . . . , 104-N. Active element 106-1, . . . , 106-N can include a processing element 108-1, 108-2, . . . , 108-N co-located with a memory resource (e.g., local memory resource) 110-1, 110-2, . . . , 110-N.

Architecture 100 can facilitate all or a portion of log analysis performed on active device 107-1, . . . , 107-N. For example, a hybrid architecture may include a portion of log analysis performed on active device 107-1, . . . , 107-N and a portion of log analysis performed on a host CPU (e.g., processing unit 102-1, . . . , 102-N).

Performing all or a portion of log analysis on an active device 107-1, . . . , 107-N can reduce and/or eliminate interference, increase streaming bandwidth, increase time to insight, decrease latency, increase real-time processing, and reduce the need to move memory (e.g., cache to processor), among other benefits. For example, because log analysis is not performed entirely on a host CPU, interference with running applications may be reduced, and because active element 106-1, . . . , 106-N is closer to passive storage element 104-1, . . . , 104-N as compared to other architectures, streaming bandwidth can be increased and latency decreased.

In an example, complex log analysis can be performed on an active device, while simpler log analysis can be performed on a host. For example, unconventional and/or more complex log analysis operations such as those that are compute intensive and can lend themselves to vector-style or digital signal processor-style acceleration or a more parallel hardware implementation can be offloaded from a host onto an active device. Examples can include clustering, pattern mining, and other anomaly detection and forecasting models. In these cases, the log analysis implementation can be offloaded to the active memory, (e.g., a custom compute entity of the active element) simplifying the host processes to reduce energy and costs, for instance.

In another example, a portion of log analysis can be performed on a number of active devices within a large data center. For instance, a number of servers generating a large amount of logs at a high rate of speed can be present in a data center. A number of active devices can analyze logs (e.g., filter, parse) before sending these logs onto dedicated clusters of servers for further analysis.

Alternatively, the number of active devices can collect and analyze the logs themselves. For example, if they have enough compute power that there is no need to send the logs to dedicated log processing clusters, the active devices can collect and analyze the logs. In such an example, active devices can be coordinated and used in a distributed manner for log analysis.

In a number of examples, pre-processing of logs can be performed within active element 106-1, . . . , 106-N prior to log analysis occurring in dedicated log analysis clusters/servers. For example, active element 106-1, . . . , 106-N perform pre-processing methods such as log data formatting, log data cleansing, log data filtering, and log data integration prior to log analysis. Similar to the discussion above with respect to large data centers, these pre-processing methods can reduce the amount of information sent to dedicated clusters or handled by the host, reducing latency, among other benefits.

In a number of embodiments, architecture 100 can also facilitate log query support and time series analysis. For example, active element 106-1, . . . , 106-N can execute SQL commands and/or assist in answering log search queries (e.g., it can help in scan, sort, and join operations). Active element 106-1, . . . , 106-N can execute statistical functions to aid in time series analysis of log data (e.g., analyzing CPU utilization). Example statistical functions can include functions for threshold/anomaly detection, prediction and forecasting, regression, and classification. In a number of examples, matrix-based operations may be supported in the active element 106-1, . . . , 106-N.

In an example, a host (e.g., host processor 102-1, . . . , 102-N) with an active device (e.g., active device 107-1, . . . , 107-N), can be used to collect system and application logs. These logs can be stored on the passive storage element of the active device (e.g., flash memory can store collected logs). The logs can be generated continuously and can include, for example, utilization logs, logs from an application, and/or logs from an operating system, among others. The compute in the active device can perform in-situ anomaly detection on the data from the operating system, utilization, and application logs and can flag the host processor if there is an urgent alert. The anomaly detection can be online and can be applied continuously on new log data as the logs are produced. Examples of anomaly detection techniques may include threshold detection, (e.g., on CPU utilization data) or pattern matching for specific event types such as ERROR messages.

In this example, providing log analysis capability in the active device enables more efficient processing of streaming log data and avoids unnecessary data movement to host CPU. Because of the proximity of the active element to the passive storage element, streaming bandwidth can be improved, latency can be reduced, real time processing of streaming logs can be increased, and time to insight (e.g., to find a problem) can be reduced. In addition, the log analysis performed on the active device may not interfere with applications running on the host because certain elements may not be shared between the two (e.g., cores, caches, memory busses).

In a number of embodiments, architecture 100 can also facilitate log mining support, active device federation, hardware management, and rule processing. Additionally or alternatively, active elements can assist in log mining operations such as, for example, association rule mining, by performing various analytic operations such as count, sort, and database scans.

Active elements 106-1, . . . , 106-N can also be used to process logs related to active devices to better manage the active devices. For example, in case of a flash memory array, the active element 106-1, . . . , 106-N can analyze storage access logs and do load balancing among the flash devices to improve performance. Other uses may include reliability analysis and performing proactive data migration or replication to prevent data loss.

In cases of logs including special events, certain event condition action rules can be processed inside active element 106-1, . . . , 106-N). For example, a special event such as a security event (e.g., multiple failed login attempts) may be an indication of a brute force attack on a server, and event condition rules can be processed inside the active element in such instances

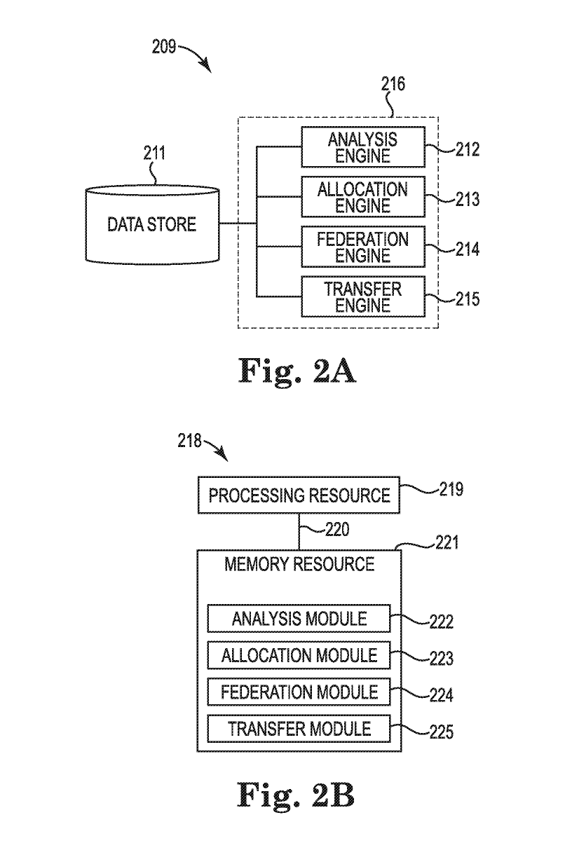

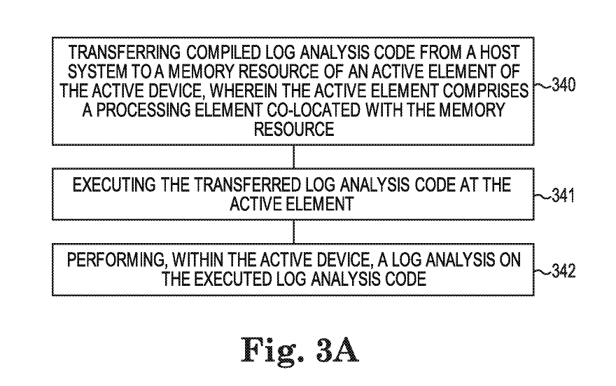

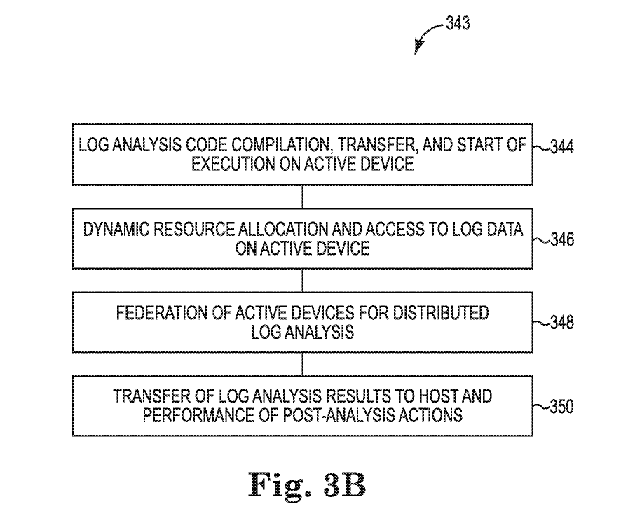

As will be discussed further herein with respect to FIGS. 2A and 3B, active devices 107-1, . . . , 107-N can be federated to provide a distributed log analysis solution, for example, for aggregation of data or to answer distributed search queries. Federating the active devices can increase efficiency and performance by coordinating their activities, communications, etc.

FIGS. 2A-2B illustrate examples of systems 209, 218 for log analysis according to the present disclosure. As illustrated in FIG. 2A, system 209 can include a data store 211, processing system 216, and/or engines 212, 213, 214, and 215. The processing system 216 can be in communication with the data store 211 via a communication link, and can include the engines (e.g., analysis engine 212, allocation engine 213, federation engine 214, transfer engine 215, etc.) The processing system 216 can include additional or fewer engines than illustrated to perform the various functions described herein.

The engines can include a combination of hardware and programming that is configured to perform a number of functions described herein (e.g., log analysis). The programming can include program instructions (e.g., software, firmware, etc.) stored in a memory resource (e.g., computer readable medium, machine readable medium, etc.) as well as hard-wired program (e.g., logic).

The analysis engine 212 can include hardware and/or a combination of hardware and programming to perform log analysis executable in a number of active devices. Performing log analysis on an active element that is in close proximity to a passive storage element (as compared to other architectures) can result in decreased latency and time to insight, as well as increased bandwidth, among other benefits.

For instance, executing log analysis code on the active device can reduce interference with a host. This can be beneficial, for example, for log analysis of data not typically used by the host. By removing the log analysis from the host and instead performing log analysis on the active devices, the amount of processing performed and resources used by the host are reduced and interference can be reduced.

The allocation engine 213 can include hardware and/or a combination of hardware and programming to perform dynamic resource allocation on the number of active devices based on the log analysis. In a number of examples, dynamic resource allocation can be performed at the active device. Dynamic resource allocation can include, for example, assigning available computing resources in an efficient manner. For instance, resource allocation (either dynamic or non-dynamic) can be performed to schedule and queue multiple log analysis functions and/or to perform memory management. Such memory management can include, for example, extending local address space to system memory (e.g., virtual addressing across system DRAM, active device, and local memory).

In a number of examples, more than one active device is present in a host, and the dynamic resource allocation can be utilized for scheduling and managing log analysis code across these multiple active devices. For example, a number of active devices may be present, and dynamic resource allocation can be performed on one or more of the active device. Dynamic resource allocation can be performed to determine which of the active devices to utilize, for example.

Dynamic resource allocation can include resource allocation that occurs “on the fly”. For instance, the dynamic resource allocation may be characterized by continuous change, activity, or progress. Dynamic resource allocation may include resource allocation that changes as conditions, inputs, and/or other factors of the architecture, environment, and/or other factors change.

The federation engine 214 can include hardware and/or a combination of hardware and programming to federate the number of active devices based on the dynamic resource allocation and the log analysis. For instance, when more than one active device is present, federation and cooperation among the active device can be employed for distributed log analysis. The active devices can be grouped and coordinated to improve performance, for example.

The transfer engine 215 can include hardware and/or a combination of hardware and programming to transfer results of the log analysis, dynamic resource allocation, and federation to a host central processing unit. As will be discussed further herein with respect to FIG. 3B, the transfers can be launched (e.g., controlled) by a host operating system, an active device operating system, a combination of the two, and system drivers, among others. In a number of examples, the transfers can be performed using flash translation layers (FTLs) when SSDs are used, a controller using microcode when hard disk drives are used, and/or using fixed logic when DRAM is used, among other transfer techniques.

In some instances, the system 209 can include an access engine (e.g., not illustrated in FIG. 2A). The access engine can include hardware and/or a combination of hardware and programming to access log data within a number of active devices in the system. This log data can be utilized in log analysis at the active device in a number of examples. Additionally or alternatively, the system 209 can include a management engine (e.g., not illustrated in FIG. 2A). The management engine can include hardware and/or a combination of hardware and programming to process and manage logs related to an active device.

FIG. 2B illustrates a diagram of an example computing device 218 according to the present disclosure. The computing device 218 can utilize software, hardware, firmware, and/or logic to perform a number of functions described herein.

The computing device 218 can be any combination of hardware and program instructions configured to share information. The hardware, for example can include a processing resource 219 and/or a memory resource 221 (e.g., computer-readable medium (CRM), machine readable medium (MRM), database, etc.) A processing resource 219, as used herein, can include any number of processors capable of executing instructions stored by a memory resource 221. Processing resource 219 may be integrated in a single device or distributed across multiple devices. The program instructions (e.g., computer-readable instructions (CRI)) can include instructions stored on the memory resource 221 and executable by the processing resource 219 to implement a desired function (e.g., log analysis).

The memory resource 221 can be in communication with a processing resource 219. A memory resource 221, as used herein, can include any number of memory components capable of storing instructions that can be executed by processing resource 219. Such memory resource 221 can be a non-transitory CRM or MRM. Memory resource 221 may be integrated in a single device or distributed across multiple devices. Further, memory resource 221 may be fully or partially integrated in the same device as processing resource 219 or it may be separate but accessible to that device and processing resource 219. Thus, it is noted that the computing device 218 may be implemented on a participant device, on a server device, on a collection of server devices, and/or a combination of the user device and the server device.

The memory resource 221 can be in communication with the processing resource 219 via a communication link (e.g., a path) 220. The communication link 220 can be local or remote to a machine (e.g., a computing device) associated with the processing resource 219. Examples of a local communication link 220 can include an electronic bus internal to a machine (e.g., a computing device) where the memory resource 221 is one of volatile, non-volatile, fixed, and/or removable storage medium in communication with the processing resource 219 via the electronic bus.

Modules 222, 223, 224, and 225 can include CRI that when executed by the processing resource 219 can perform a number of functions. The number of modules 222, 223, 224, and 225 can be sub-modules of other modules. For example, the analysis module 222 and the allocation module 223 can be sub-modules and/or contained within the same computing device. In another example, the number of modules 222, 223, 224, and 225 can comprise individual modules at separate and distinct locations (e.g., CRM, etc.).

Each of the modules 222, 223, 224, and 225 can include instructions that when executed by the processing resource 219 can function as a corresponding engine as described herein. For example, the federation module 224 can include instructions that when executed by the processing resource 219 can function as the federation engine 214. In another example, transfer module 225 can include instructions that when executed by the processing resource 219 can function as the transfer engine 215.

FIGS. 3A-3B illustrate flow charts of examples of methods 341, 343 for log analysis according to the present disclosure. As illustrated at 340 of FIG. 3A, compiled log analysis code can be transferred from a host system to a memory resource of an active element of the active device. In a number of examples, the active element can include a co-located processing element and memory resource.

Log analysis code can be compiled for running on a particular architecture. For example, the code can be compiled such that it is compatible for running on an active device architecture (e.g., architecture 100 as illustrated in FIG. 1). The code that runs on the active device can be compiled elsewhere, (e.g., on a host system or other system) and transferred to the active device to be run.

The results of the log analysis can include a pre-processing (e.g., initial pre-processing) of the logs, and the results of the pre-processing can be sent to dedicated servers (e.g., separate dedicated servers) for log processing. In a number of examples, the results of the log analysis can be written to the passive storage element, which can be co-located with the active element on the active device

At 341, the transferred log analysis code is executed at the active element, and at 342, a log analysis is performed on the transferred log analysis code. The log analysis can be performed within the active device (e.g., executable in the active device). In a number of examples, the log analysis is executable in the active device through a host (e.g., host CPU) or an independent operating system on the active device.

FIG. 3B illustrates a more detailed example as compared to method 341 of a method 343 for log analysis according to the present disclosure. At 344, log analysis code can be compiled, transferred, and the code can be executed on the active device. As previously noted, log analysis code can be compiled and transferred to the active device, and can occur in a number of ways.

For example, moving the log analysis code (e.g., binary log analysis code) can include a host CPU controlling the movement. For example, a host operating system can launch the process of moving and analyzing the log analysis code on the active device. This may be the case when there is a single operating system for both the host CPU and the active device.

In an example including an operating system on the host and on a separate operating system on the active device (e.g., on the active device), one and/or both operating systems may launch the process of moving and analyzing the log analysis code on the active device.

In an example where the active device acts as a main device for the overall system, drivers within the system may be responsible for launching the process of moving and analyzing the log analysis code on the active devices. Other transfer methods may also be used to transfer the code from the active element or other location to the active device. Once transferred, the code can be executed and analyzed on the active device.

At 346, resources can be dynamically allocated and log data can be accessed on the active device (e.g., based on the log analysis). File systems and memory data structures within the host and/or active device can be given access at the active device to log data that may be stored in the active element (e.g., in the memory resource). For instance, this is how the log analysis code can access the log data.

At 348, active devices can be federated for distributed log analysis. As previously noted, when more than one active device is present, federation and cooperation among the active device can be employed for distributed log analysis. A number of active devices per host can be leveraged for data parallelism, for example.

For example, if log analysis code is to be run in patterns (e.g., distributed anomaly detection, distributed pattern mining) the architecture may include a number of active devices on a single system, in which case parallel code is running on those number of active devices. Logic (e.g., application logic) can be utilized to coordinate the parallelism. In another example, different machines and active devices may be working together via a communication channel (e.g., Ethernet). Logic (e.g., application logic) can be utilized to coordinate and manage the communication.

At 350, log analysis results can be transferred to a host (e.g., host CPU), and post-analysis actions can be performed. On completion of log analysis execution, data can be transferred to host processors and/or it can be set over a network to another system (e.g., a system manager console). Additionally or alternatively, a passive storage element can store the log data for later consumption by the host or other servers. The data may also be filtered pre- or post-transfer, and the data can be transferred to a host or other system. Such transfers can take place in similar manners to those transfers discussed with respect to element 344.

Actions can be performed in response to the log analysis and/or resource allocation. For example, an appropriate action needed as a result of the log analysis can be performed such as, for instance, raising alerts, making recommendations, analyzing hardware, tuning hardware, tuning system parameters, load balancing, and migrating data across memory and/or storage devices, among others.

In a number of examples, an action performed in response to log analysis can include a response to event detection. For instance, if an event (e.g., access patterns indicating virus-like activities and/or frequent rule/threshold violations, among others) is detected as part of the log analysis, a host (e.g., host CPU) can be flagged. For example, an alert message can be sent and/or a hardware interrupt can be sent from a passive storage element to a host. Additionally or alternatively, a web services call and/or a simple network management protocol alert can be deployed by the active device. For instance, events such as access patterns indicating virus-like activities or frequent rule/threshold violations may be detected during log analysis, and this information can be passed along to a host by the active device.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A method for log analysis, comprising:
transferring compiled log analysis code from a host system to a memory resource of an active element of the active device,
wherein the active element comprises a processing element co-located with the memory resource;
executing the transferred log analysis code at the active element; and
performing, within the active device, a log analysis on the executed log analysis code.

2. The method of claim 1, wherein results of the log analysis comprise a pre-processing of the logs.

3. The method of claim 2, wherein the results of the pre-processing of the logs are sent to dedicated servers for log processing.

4. The method of claim 1, comprising writing results of the log analysis to a passive storage element.

5. The method of claim 4, wherein the passive storage element is co-located with the active element on the active device.

6. A log analysis device, comprising:
a processing resource;
an active device communicatively coupled to the processing resource and comprising:
an active element comprising a co-located processing element and memory resource; and
a passive storage element communicatively coupled to the active element; and
a non-transitory computer-readable medium storing a set of instructions executable by the processing resource to:
perform a first portion of a log analysis at the processing resource by executing a first set of transferred log analysis code;
perform a second portion of the log analysis at the active device by executing a second set of transferred log analysis code at the active element;
allocate resources of the log analysis device at the active device based on the first log analysis and the second log analysis; and
take an action based on the first portion and the second portion of the log analysis and the resource allocation.

7. The device of claim 6, wherein the instructions executable to take an action are executable to raise an alert in response to a detected anomaly during at least one of the first portion and the second portion of the log analysis.

8. The device of claim 6, wherein the instructions executable to allocate resources of the log analysis device are executable to perform memory management of the log analysis device.

9. The device of claim 6, wherein the instructions executable to allocate resources of the log analysis device are executable to schedule a number of log analysis functions to be performed at the active device.

10. The device of claim 6, wherein the processing element comprises at least one of a programmable logic device, a field programmable gate array (FPGA), a central processing unit (CPU), and a low-power CPU.

11. The device of claim 6, wherein the passive storage element comprises at least one of a memristor, a non-volatile memory, a solid state drive, a dynamic random-access memory, a phase change random access memory, flash memory, and a spin torque transfer random-access memory.

12. A system for log analysis, comprising:
a processing resource; and
a memory resource communicatively coupled to the processing resource containing instructions executable by the processing resource to implement an analysis engine, an allocation engine, a federation engine and a transfer engine, wherein:
the analysis engine performs log analysis executable in a number of active elements within a number of active devices;
the allocation engine performs dynamic resource allocation on the number of active devices based on the log analysis;
the federation engine federates the number of active devices based on the dynamic resource allocation and the log analysis; and
the transfer engine transfers results of the log analysis, dynamic resource allocation, and federation to a host central processing unit.

13. The system of claim 12, wherein the federation engine groups the number of active devices and coordinates resources of the active devices during federation.

14. The system of claim 12, comprising an access engine to access log data within the number of active devices of the system.

15. The system of claim 12, comprising a management engine to process and manage logs related to the active devices.
